(19) United States
(12) Patent Application Publication
(10) Pub. No.: US 2007/0153507 A1
(43) Pub. Date: Jul. 5, 2007

(54) PERSONAL FLOATATION DEVICE WITH WATER ACTIVATED LIGHT

(75) Inventors: Kevin J. Tarter, Wichita, KS (US); Darin M. Webb, Wichita, KS (US)

Correspondence Address: LEYDIG, VOIT & MAYER, LTD.;(SEATTLE OFFICE), TWO PRUDENTIAL PLAZA, SUITE 4900, CHICAGO, IL, 60601-6731, US

(73) Assignee: THE COLEMAN COMPANY, INC., Wichita, KS (US)

(21) Appl. No.: 11/550,277

(22) Filed: Oct. 17, 2006

Related U.S. Application Data
(63) Continuation-in-part of application No. 11/379,532, filed on Apr. 20, 2006.
Application No. 11/379,532 is a continuation-in-part of application No. 11/325,911, filed on Jan. 4, 2006.

(51) Int. Cl. F21L 4/00

(52) U.S. Cl. 362/208; 362/1

(57) ABSTRACT

A personal floatation device that includes contacts that close a circuit when the personal floatation device is in water. The closed circuit provides a connection between batteries and a lamp, lighting the lamp. The personal floatation device is buoyant so that it floats when dropped in the water.

### REFERENCE TO RELATED APPLICATION

This application is a continuation in part of U.S. application Ser. No. 11/379,532, filed Apr. 20, 2006, which is a continuation in part of U.S. application Ser. No. 11/325,911, filed Jan. 4, 2006, both of which are incorporated herein by reference.

### TECHNICAL FIELD OF THE INVENTION

The present invention is directed to floatation devices, and more particularly to personal floatation devices.

### BACKGROUND OF THE INVENTION

A personal floatation device (PFD) is device used to keep a person afloat. A life jacket, a life preserver, and a life vest are three types of PFD's, although PFD's may take other forms. A PFD may be, but need not be, a device used to keep a person afloat conforming to government standards concerning such devices.

A life vest is a PFD in the form of a buoyant vest. As an example, a life vest may include buoyant material that extends around a torso of a user's body covering at least a portion of the user's chest and a portion of the user's back below the user's neck.

A life jacket is a PFD similar to a buoyant vest. As an example, a life jacket may be substantially in the form of a horseshoe so that, when worn by a user, buoyant material is covers at least a portion of the user's chest and the back of the user's neck. The buoyant material may be held to the user with a strap extending around a torso of a user's body and the two legs of the horseshoe shape may be held together with one or more straps and/or fasteners.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment, a personal floatation device (PFD) is provided. The PFD includes buoyant material, a circuit, a power supply, a lamp or other signaling device, and contacts. When the contacts make contact with water, the circuit provides power to and turns on the lamp.

Other features of the invention will become apparent from the following detailed description when taken in conjunction with the drawings, in which:

### BRIEF DESCRIPTION OF THE DRAWINGS

FIG. 1 shows a side perspective view of a flashlight in accordance with an embodiment, with the flashlight shown floating in water;

FIG. 2 shows a cutaway view of the flashlight of FIG. 1;

FIG. 3 shows a circuit that may be used for the flashlight of FIG. 1;

FIG. 4 shows a side perspective view of a key fob in accordance with an embodiment, with the key fob shown floating in water;

FIG. 5 shows a side perspective view of a lantern in accordance with an embodiment, with the lantern shown floating in water;

FIG. 6 shows a side perspective view of an alternate embodiment of a flashlight, with the flashlight shown floating in water;

FIG. 7 is an exploded side perspective view of the flashlight of FIG. 6, shown as being installed in a charging cradle;

FIG. 8 shows a side perspective view of a life vest in accordance with an embodiment; and

FIG. 9 shows a side perspective view of the life vest of FIG. 8 as worn by a person floating in the water in accordance with an embodiment of the invention.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

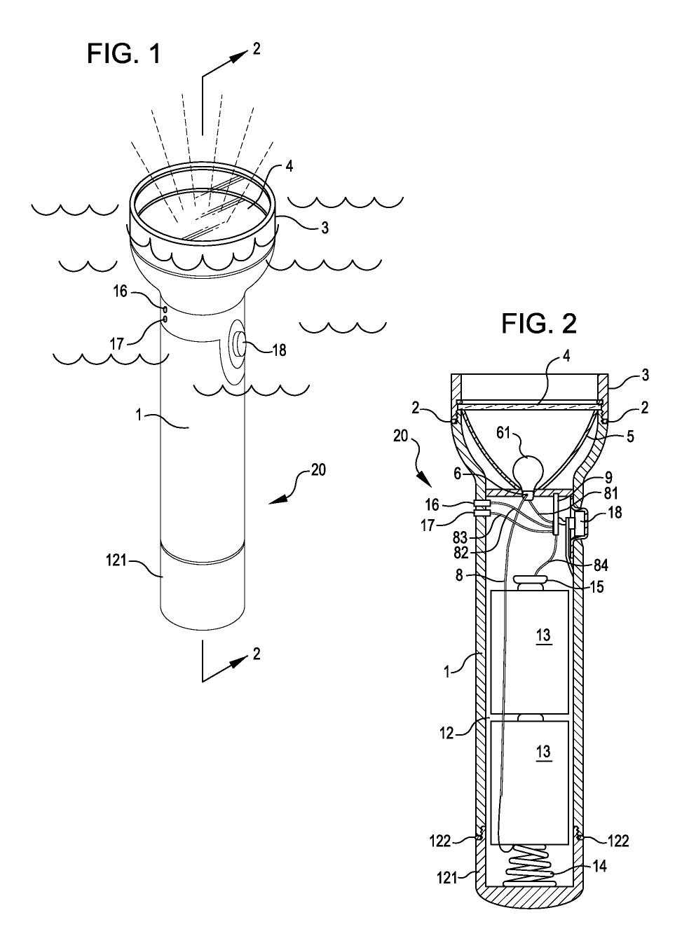

Referring now to the drawings, in which like reference numerals represent like parts throughout the several views, FIG. 1 shows a flashlight 20 in accordance with an embodiment of the invention. The flashlight 20 includes a housing 1 having a waterproof seal 2 (FIG. 2), such as an O-ring, at an upward portion. The O-ring 2 forms a seal between the housing 1 and a lamp cover 3. A lens 4 extends across the lamp cover 3, and a reflector 5 is mounted behind the lens and within the lamp cover. A bulb 61 having a bulb base 6 is mounted in the reflector 5. Although a bulb 61 is shown, the flashlight may include any form of lamp, including a light emitting diode (LED), an incandescent lamp, a fluorescent lamp, or other lights.

The flashlight 20 includes batteries 13 mounted in a battery box 12 defined by an interior of the housing 1. The housing 1 includes a bottom cap 121 for providing access to the interior of the battery box 12 to replace the batteries 13. The bottom cap 121 includes an O-ring 122 or another seal to form a watertight connection between the bottom cap 121 and the housing 1. As an alternate to batteries 13, a rechargeable battery or batteries may be used within the flashlight 20.

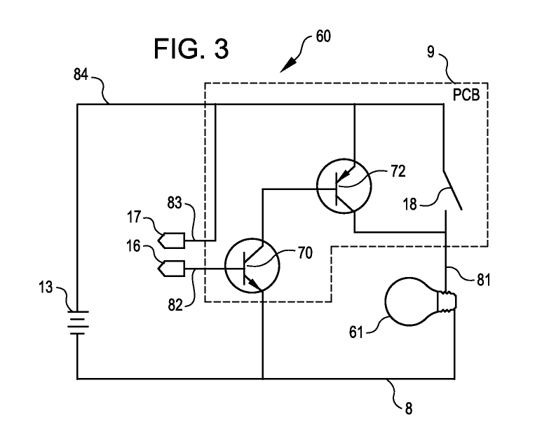

The battery box 12 includes a negative spring 14 and a positive contact 15 for contacting the negative and positive terminals of the batteries 13, respectively. A wire or cable 8 (FIG. 3) extends from the negative spring 14 to a first terminal of the bulb 61. This wire or cable, and the other wires or cables described herein, may alternatively be metal conductive contact plates or other suitable conductive connections. An additional wire 81 extends from a second terminal of the bulb 61 to a printed circuit board 9. A third wire 82 extends from the printed circuit board 9 to a first current conductor 16 that extends outside of the housing 1. A fourth wire 83 extends from the printed circuit board 9 to a second current conductor 17, which also extends outside the housing 1. A fifth wire 84 extends between the positive contact 15 and the printed circuit board 9. A manual switch 18 is provided and is connected to the printed circuit board 9. The switch includes a watertight seal in a manner known in the art.

In the embodiment shown, the flashlight 20 floats. That is, the flashlight 20 stays at a top surface of a body of water, even if only a slight portion or none of the flashlight extends above a surface of the water. The floatation provided may be sufficient only to make the flashlight buoyant, or may make a portion of the flashlight extend out of the water. To this end, the flashlight 20 is preferably sized so that the air pocket formed within the flashlight, for example behind the reflector 5, is sufficient to support the flashlight 20 along with the batteries 13, when the flashlight 20 is accidentally dropped in water. For the flashlight 20 shown in the drawings, a larger head portion is provided for this function, although air pockets may be formed at any location so as to provide this function. The size of an air pocket needed to float a flashlight may be determined empirically or by experimentation. In addition, the flashlight may be floatable in other ways, for example by the addition of Styrofoam or other buoyant materials.

In the embodiment shown in FIG. 1, the air pocket is positioned so that the flashlight 20 floats with the light side up in the water. A flashlight may alternatively be configured to float on its side or upside down.

FIG. 1 shows the exterior of the flashlight 20, and is helpful in showing that the first current conductor 16 and the second current conductor 17 are exposed on the exterior of the flashlight. These current conductors 16, 17 are positioned so that they are in contact with water when the flashlight 20 is floating, regardless of the orientation of the flashlight. In the embodiment shown in the drawings, as can be seen in FIG. 2, the flashlight is mostly submerged when floating at a surface of the water. Because the flashlight 20 is only slightly buoyant, the head of the flashlight sticks only slightly above the surface of the water. The current conductors 16, 17 are positioned at a juncture of the head of the flashlight 20 and the housing 1, and thus are positioned below the water.

Although the head of the flashlight 20 is shown at the surface of the water, a flashlight may be configured in a different manner so that a different portion is presented at the surface. As an example, a flashlight may float on its side or upside down.

FIG. 3 shows a circuit 60 that may be used with the flashlight 20 in accordance with an embodiment. In FIG. 3, the circuit 60 is shown as including batteries 13 and a lamp 61, but these and other components that are attached to the circuit may be considered as elements of the circuit, or as elements separate from the circuit.

As can be seen, the manual switch 18 may be used to close the circuit with the batteries 13 to turn on the bulb 61. Alternatively, an electrical connection may be provided between the first and second current conductors 16, 17. This connection may be provided, for example, when the flashlight 20 is dropped in water. Water acts as a conductor between the two current conductors 16, 17, and thus a signal is supplied to a transistor 70. This transistor in turn provides a signal to a second transistor 72, which closes the circuit between the batteries 13 and the bulb 61, turning on the bulb.

As can be understood, the flashlight 20 of the present invention is very useful when dropped in water. Not only does the flashlight 20 float, but, if the flashlight 20 is not already turned on, the bulb 61 turns on as a result of water arcing across the contacts 16, 17. Thus, the flashlight is easy to recover after being dropped in the water.

Although the flashlight 20 is of conventional form, embodiments of the invention may be used on other flashlight designs. In addition, the concepts of the present invention may be applied to any lighting appliance, including an electric lantern or a key fob.

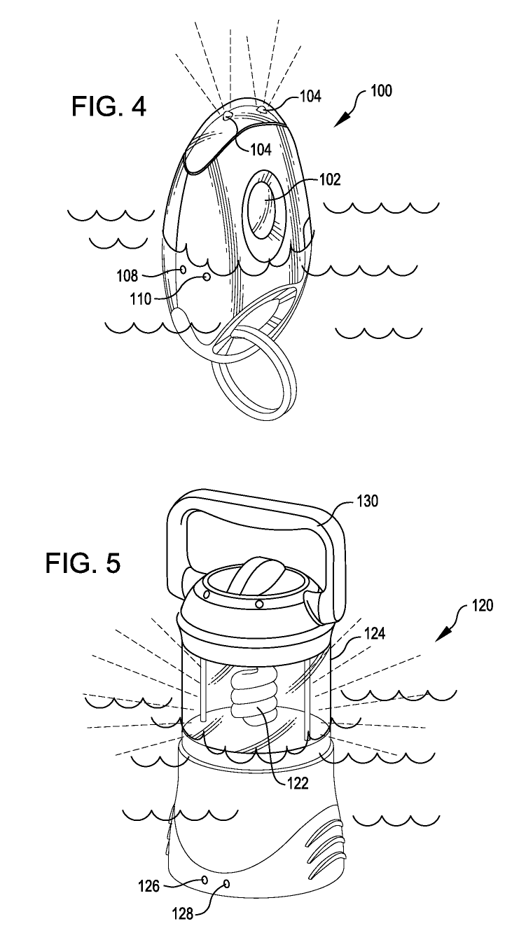

For example, a key fob 100 is shown in FIG. 4. The key fob 100 includes a switch 102 and two light emitting diode (LED) lamps 104 mounted behind a clear lens 106, although one LED or more than two may be used. For the embodiment shown in the drawings, the key fob 100 includes a housing having watertight seals and is of sufficient size to include an air pocket for flotation of the key fob. As with the flashlight 20, the key fob 100 includes current conductors 108, 110 that are similar to the current conductors 16, 17. In addition, the key fob includes a circuit such as the circuit 60 or a circuit that is capable of performing a similar function.

As another example, a lantern 120 is shown in FIG. 5. The lantern 120 includes a fluorescent bulb 122 mounted within a globe 124.

For the embodiment shown in the drawings, the lantern 120 includes airtight seals and has sufficient interior space to include an air pocket that is suitable for floating of the lantern. The lantern includes current conductors 126, 128 that are similar to the current conductors 16, 17, and also includes a circuit that is similar to, or performs the same function as, the circuit 60.

For the embodiment shown in the drawings, the lantern 120 is configured so that it floats in an upright manner when dropped in the water. If desired, a portion of the globe 124 may be exposed above the surface of the water, or the globe may be completely submersed in the water. A handle 130 is provided at the top of the lantern 120, and may extend out of the water once the lantern is dropped into the water.

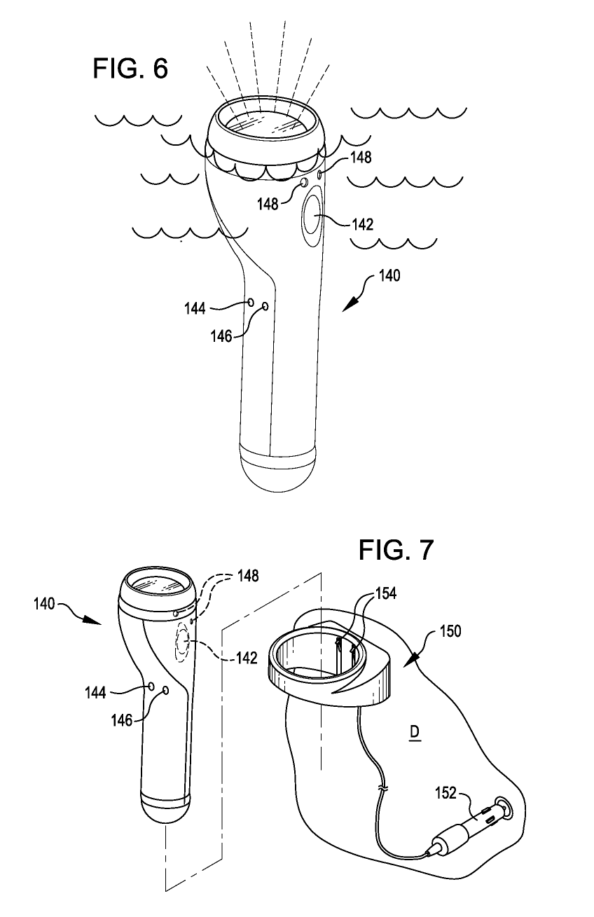

FIG. 6 shows an alternate embodiment of the flashlight 140. The flashlight 140 includes a switch 142 and current conductors 144, 146 that are similar to the current conductors 16, 17. In addition, the flashlight 140 includes contacts 148. The contacts 148 are positioned so that they may engage posts 154 on the inside of a charging cradle 150 (FIG. 7).

In accordance with an embodiment, the charging cradle 150 is designed to be mounted in a vehicle, including automobiles, boats, and recreational vehicles. The cradle 150 may, for example, include an adhesive strip for adhering to a dashboard, or may be configured to fit into a cup holder on a dashboard. A cigarette lighter adapter 152 is provided for providing power to the charging cradle 150. If desired, the charging cradle 150 may be directly attached to the cigarette lighter adapter 152. In an alternate embodiment shown in the drawings, a cord is provided between the cigarette lighter adapter 152 and the charging cradle 150.

When the flashlight 140 is placed inside the charging cradle 150, the contacts 148 align with the post 154, and rechargeable batteries (not shown) within the flashlight are charged. In addition, the flashlight 140 provides the floating and water activated functions described above.

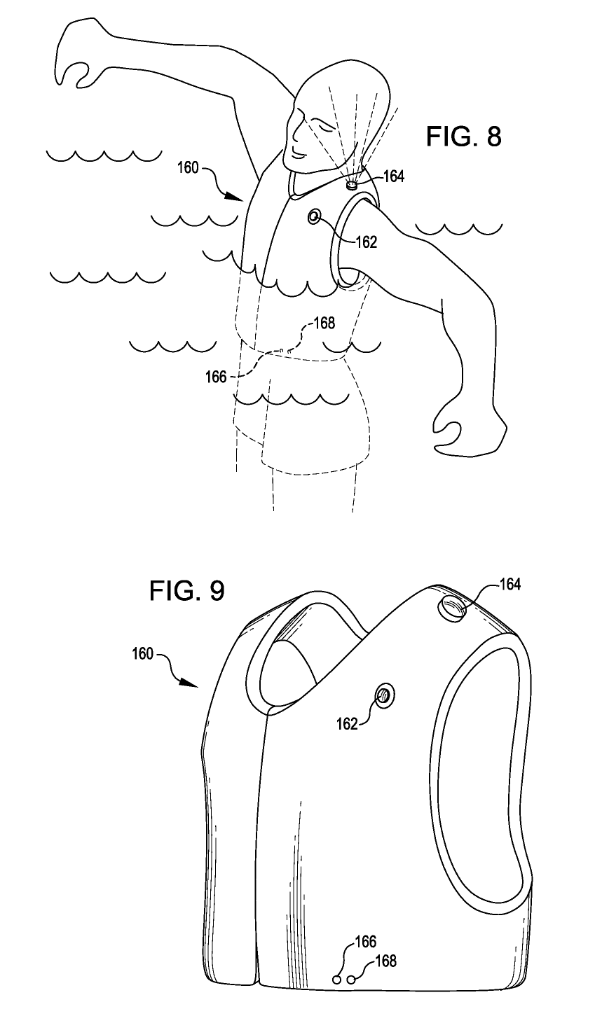

FIG. 8 shows a life vest 160 in accordance with an embodiment. As shown in the drawings, the life vest 160 includes a lamp 164, current conductors (contacts) 166, 168 that are similar to the contacts 16, 17, and a circuit such as the circuit 60 or a circuit that is capable of performing a similar function. In accordance with an embodiment, the life vest 160 includes closed-cell foam to provide buoyancy, but the invention may be practiced with any buoyant material, or a combination of buoyant materials may be used.

The lamp 164 may be located in any suitable location on the life vest 160, such as on one or more of the breasts, on the back, on the edge between the inside and outside of the vest or anywhere else on the vest. In an embodiment, the lamp 164 is positioned and arranged so that it is visible from a long distance away when the life vest 160 is worn by a user. In an embodiment, the lamp 164 projects light in front of a user wearing the vest. Mounting the lamp 164 on a shoulder of the life vest 160, such as is shown in FIG. 8, provides both of these functions, and removes the lamp 164 from where it may impede with the arms of the wearer.

FIG. 8 shows the lamp 164 attached to the outside of the life vest material, but attachment may be made in a variety of ways. For example, a lamp may be integrated into the body of the life vest 160 so that the face of the lamp is flush with the material of the life vest body or so that the lamp protrudes from the life vest body. In addition, the lamp 164 may be attached to the life vest body, for example by a cable or string. In any event, in an embodiment, the lamp 164 is associated with the life vest so that it remains connected thereto when worn by a user. If desired, the lamp 164 may be removable or may become a handheld device, for example by extending a cord attached the lamp or by having batteries integrated into the lamp.

FIG. 8 shows the life vest 160 with one lamp 164. The present invention need not be limited to one lamp, but two or more lamps may be used. If two or more lamps are used, they may be located close together to provide the effect of one bright lamp, they may be located in various positions in or on the life vest, or there may be several groups of closely-placed lamps in various positions in or on the life vest.

In accordance with an embodiment of the invention, the lamp 164 includes a LED. Other types of light sources may be used such as incandescent bulbs, fluorescent bulbs or lights, or anything capable of emitting electromagnetic radiation. In accordance with an embodiment, the lamp 164 shines continuously when a circuit in the circuitry is closed. The circuitry may also cause the lamp to flash when a circuit is closed, or a switch may be provided that allows a user to choose whether the lamp shines continuously, flashes, and/or flashes in one of several modes.

As shown in FIG. 8, much of the circuitry is integrated into the body of the life vest 160 and is not visible. The circuitry may also be located on the inside of the vest, the outside of the vest, a combination of the inside and outside of the vest, or the circuitry may be partially integrated into the body of the life vest or not integrated into the vest. In accordance with an embodiment, the circuitry is waterproof. The circuitry may also be water resistant or otherwise constructed in a manner such that the circuit will function in wet conditions for a sufficient amount of time.

As shown in FIG. 8, the contacts 166, 168 are located on the outside of the life vest 160. In general, the contacts 166, 168 may be located in any suitable part of the vest. For example, they may be located on the bottom of the vest, on the inside of the vest, or in any suitable location such that the contacts 166, 168 will have contact with water when a user of the life vest 160 is in the water. In addition, the life vest may have one or more sets of contacts located in various places throughout the vest. There may also be one or more sets of contacts such that, in each set, if two contacts of the set come into contact with the water, a circuit is completed and the lamp emits light. Finally, one or more contacts may be integrated into the main body of a PFD while one or more other contacts may not be integrated into the main body.

As shown in FIG. 8, the life vest 160 includes a switch 162 in accordance with an embodiment. The switch is part of a circuit, such as the circuit 60, and allows a user to turn the lamp 164 on as described above. As shown in FIG. 8, the switch is located on one of the breasts of the life vest 160, but the switch may be located in any location on or in the vest. The life vest 160 may not include a switch, or a switch may be similar to the switch described above, or it may be any device suitable for closing a circuit, whether directly or indirectly. The circuit may also be configured so allow a user to turn the lamp 164 off when it is on due to water making contact with the contacts 166, 168, for example, in order to conserve the power supply.

As shown in FIG. 3, a circuit 60 for the life vest may include batteries 13. Accordingly, the life vest 160 may use one or more batteries in its circuit or it may use an alternate power source. For example, it may use a hand-powered generator, or one or more devices capable of converting solar energy into electricity. The life vest 160 may also include a combination of power sources, and may include one or more batteries that are able to be charged by another power source. In general, any power supply or power supplies used in the present invention may be integrated into the main body of a PFD or may be otherwise connected to the personal floatation device.

As shown in FIG. 8, in one embodiment, a battery is integrated into the body of the life vest 160. Batteries may be located as such, or they may be located in alternate locations. For example, the life vest may contain pockets to hold one or more batteries, or a battery pack may be attached to the life vest 160 in any location, or a cord may lead to batteries that attach to other parts of the body, such as a belt worn by a user. Batteries used in the present invention may be removable by the user, or they may be permanently integrated into the body of the life vest 160. The life vest 160 may also include contacts for charging the batteries.

As shown in FIG. 8, a life vest 160 is shown in accordance with an embodiment of the invention. The present invention is not limited to a vest. In general, the present invention may be practiced in any style PFD such as a life jacket or life preserver. For example, a life preserver in the form of a ring may include a lamp, a power supply, a circuit such as 60, and contacts similar to 16, 17. It may also include a switch similar to 162. The lamp may be located in any place on the PFD such that it is visible to others when the PFD is in use. Similarly, the contacts may be located in any place on the PFD such that the contacts make contact with water when the PFD is in use. The circuit may be located in any suitable place, such as inside the PFD, and the switch may be located in any suitable place, such as a place easily accessible to a user. Finally, the power supply may be located in any suitable place, such as inside the PFD, or attached to the PFD such that a user may access it.

When a user of the life vest 160 is in the water (FIG. 9), current flows between the contacts 16, 168, and the lamp 164 emits light. Such functionality in a life vest provides several advantages. For example, a life vest 160 including a lamp 164 helps search and rescue workers find people in need of rescue. The lamp 164 is particularly helpful in conditions of low visibility such as at night, or in a fog. Having contacts 166, 168 across which current flows when the life vest 160 is in contact with the water ensures that the lamp 164 will emit light even if the user of the life vest 160 is unconscious. In addition, a lamp 164 that automatically emits light when the contacts 166, 168 are in contact with water ensures that the lamp will function regardless of whether the user knows how to otherwise cause the lamp 164 to emit light, or whether the user is under too much stress to remember to turn a lamp on. Moreover, the automatic functionality removes a need to instruct users on how to turn a lamp on, instructions which users may easily forget or ignore.

In an embodiment, a switch 162 (FIG. 8) may be added to the circuit for the lamp 164. Having a switch 162 ensures that a user of a life vest 160 may cause the lamp 164 to emit light even if the vest is not in the water, for example if the user is in a life raft in low-visibility conditions or if the user simply is in need of a light source.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, integrated with, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A personal floatation device, comprising:
a buoyant main body;
a circuit connected to the main body;
a power supply connected to the circuit;
a lamp connected to the circuit;
water contacts connected to the circuit, the circuit being configured to provide power to and turn on the lamp when the contacts come in contact with water, and wherein at least one of the circuit, the power supply, the lamp, and at least one water contact is integrated into the main body.

2. The personal floatation device of claim 1, wherein the personal floatation device comprises a vest.

3. The personal floatation device of claim 2, wherein the vest comprises a shoulder, and the lamp is located on or near the shoulder.

4. The personal floatation device of claim 1, wherein the personal floatation device comprises a life jacket.

5. The personal floatation device of claim 4, wherein the vest comprises a shoulder, and the lamp is located on or near the shoulder.

6. The personal floatation device of claim 1, further comprising a switch connected to the circuit, the circuit being configured such that activating the switch causes the circuit to provide power to the lamp.

7. The personal floatation device of claim 1, wherein the power supply comprises one or more batteries.

8. The personal floatation device of claim 1, wherein the lamp comprises one or more members of the set of a light emitting diode, an incandescent lamp, and a fluorescent lamp.

9. The personal floatation device of claim 1, wherein a portion of the personal floatation device is configured to be worn on or near a user's shoulder with the lamp located at the portion.

10. The personal floatation device of claim 1, wherein the contacts are positioned to be in contact with water when a user uses the personal floatation device in water.

11. The personal floatation device of claim 1, wherein the power supply is removable.

12. The personal floatation device of claim 1, wherein the power supply is at least one of integrated into or permanently attached to the main body.

13. The personal floatation device of claim 1, further comprising contacts for charging the power supply.
